(19) United States
(12) Patent Application Publication
(10) Pub. No.: US 2024/0420412 A1
(43) Pub. Date: Dec. 19, 2024

(54) IMAGE PROCESSING APPARATUS, CONTROL METHOD, AND STORAGE MEDIUM

(71) Applicant: CANON KABUSHIKI KAISHA, Tokyo (JP)

(72) Inventor: Kazufumi ONUMA, Kanagawa (JP)

(21) Appl. No.: 18/742,426

(22) Filed: Jun. 13, 2024

(30) Foreign Application Priority Data
Jun. 13, 2023 (JP) 2023-097066

(51) Int. Cl. G06T 15/20; G06T 7/20; G06T 19/20

(52) U.S. Cl. CPC G06T 15/205; G06T 7/20; G06T 19/20; G06T 2219/2012; G06T 2219/2016; G06T 2219/2021

(57) ABSTRACT

An image processing apparatus includes one or more memories storing instructions, and one or more processors executing the instructions to detect a position of a subject, generate a virtual viewpoint image using three-dimensional shape data of the subject, and display subject information related to movement of the subject on the virtual viewpoint image, based on information on the detected position of the subject.

### BACKGROUND

### Field of the Disclosure

The present disclosure relates to an image processing apparatus that generates a virtual viewpoint image.

### Description of the Related Art

There is a virtual viewpoint image generation system that, based on images captured by an imaging system using a plurality of cameras, generates a virtual viewpoint image that is an image viewed from a virtual viewpoint specified by a user. Japanese Patent Application Laid-Open No. 2017-211828 discusses a system that transmits images captured by a plurality of cameras, and extracts from the captured images, an image with large changes as the foreground image and an image with small changes as the background image by an image computing server (image processing apparatus).

In the field of sports, information on players' positions is detected by the sensors attached to the players and from the images captured in a plurality of directions. The information on the players' positions is used to provide coaching to the players and commentary in broadcast programs, for example.

On the other hand, information on players' moving speeds and moving directions is rapidly changing information. For this reason, if information on players is represented in numerical values, for example, it may be hard for viewers to grasp the information at a glance.

### SUMMARY

According to an aspect of the present disclosure, an image processing apparatus includes one or more memories storing instructions, and one or more processors executing the instructions to detect a position of a subject, generate a virtual viewpoint image using three-dimensional shape data of the subject, and display subject information related to movement of the subject on the virtual viewpoint image, based on information on the detected position of the subject.

Further features of the present disclosure will become apparent from the following description of exemplary embodiments with reference to the attached drawings.

### BRIEF DESCRIPTION OF THE DRAWINGS

FIG. 1 is a block diagram illustrating an example of an image processing system.

FIG. 2A is a diagram illustrating an example of positions of subjects, FIG. 2B is a diagram illustrating an example of the subjects extracted by a shape extraction unit, FIG. 2C is a diagram illustrating an example of positions of subjects in different states, FIG. 2D is a diagram illustrating an example of the subjects extracted by the shape extraction unit, and FIG. 2E is a diagram illustrating an example of extracted shapes.

FIG. 3A is a diagram illustrating an example of extracted shapes with identifiers, and FIG. 3B is a diagram illustrating an example of a graphical user interface for displaying the extracted shapes and the identifiers.

FIG. 4 is a diagram illustrating an example of typical positions.

FIG. 5 is a flowchart of an example of a tracking analysis process by a tracking unit.

FIG. 6 is a flowchart of an example of a subject information superimposition process by an image generation unit.

FIGS. 7A to 7D are diagrams illustrating an example of images generated by the image generation unit.

FIGS. 8A to 8C are diagrams illustrating an example of marks indicating the moving speed and the direction of a subject.

FIG. 9 is a block diagram illustrating a configuration example of hardware of a computer.

### DESCRIPTION OF THE EMBODIMENTS

### (System Configuration and Operations of Image Processing Apparatus)

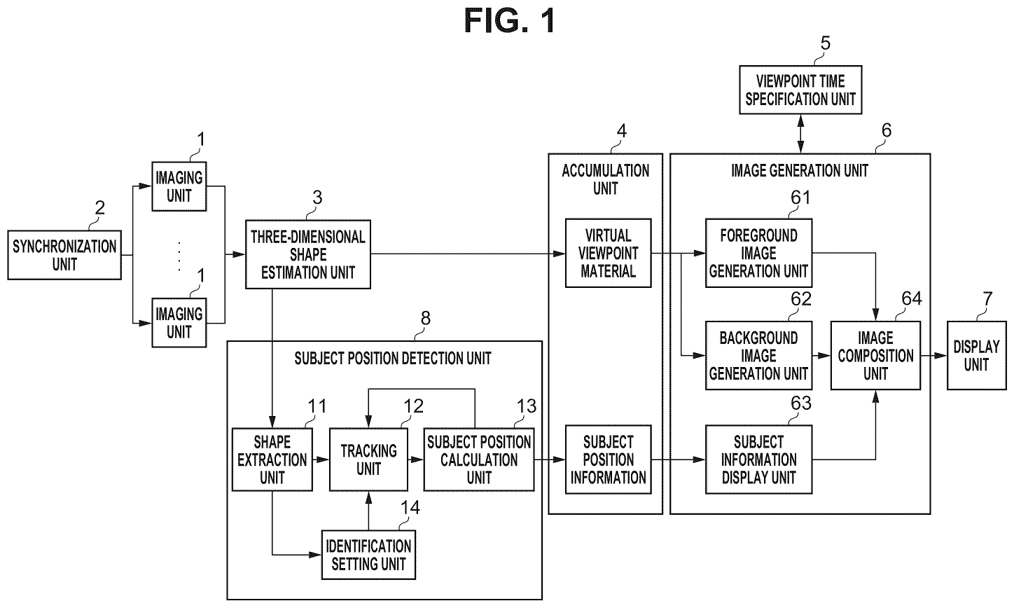

FIG. 1 illustrates an example of configuration of an image processing system that generates a virtual viewpoint image according to a first exemplary embodiment. The image processing system includes imaging units 1, a synchronization unit 2, a three-dimensional shape estimation unit 3, an accumulation unit 4, a viewpoint specification unit 5, an image generation unit 6, a display unit 7, and a subject position detection unit 8. The image generation unit 6 includes a foreground image generation unit 61, a background image generation unit 62, a subject information image generation unit 63, and an image composition unit 64. The subject position detection unit 8 includes a shape extraction unit 11, a tracking unit 12, a subject position calculation unit 13, and an identification setting unit 14. The image processing system may be formed of one image processing apparatus or may be formed of a plurality of image processing apparatuses. The following description is based on the assumption that the image processing system is one image processing apparatus.

An outline of operations of the components in the image processing apparatus that generates a virtual viewpoint image to which the present system is applied will be described. The plurality of imaging units 1 captures images in synchronization with one another based on a synchronization signal from the synchronization unit 2. The imaging units 1 output the captured images to the three-dimensional shape estimation unit 3. Because the imaging units 1 can capture images from a plurality of directions, the imaging units 1 are arranged so as to surround an imaging area including the subject. The three-dimensional shape estimation unit 3 uses the input images captured from the plurality of viewpoints to extract the silhouette of the subject, for example, and then generates the three-dimensional shape of the subject using visual hull or the like. The three-dimensional shape estimation unit 3 outputs the generated three-dimensional shape of the subject and the captured images to the accumulation unit 4. The subject is an object that is the target of three-dimensional shape generation, which includes a human, an article treated by the human, and others.

Although the details will be described below, the subject position detection unit 8 detects the position of the subject in the imaging area and outputs the detected subject position information to the accumulation unit 4.

The accumulation unit 4 saves and accumulates data (material data) for use in generation of a virtual viewpoint image. The data for use in generation of a virtual viewpoint image specifically includes the captured images and the three-dimensional shape of the subject input from the three-dimensional shape estimation unit 3, camera parameters such as the positions, postures, and optical characteristics of the imaging units, and the subject position information acquired by the subject position detection unit 8. As the data for use in generation of background of a virtual viewpoint image, a background model and a background texture image are saved (recorded) in advance in the accumulation unit 4.

The viewpoint specification unit 5 includes a viewpoint operation unit that is a physical user interface such as a joy stick or a jog dial not illustrated and a display unit that displays the virtual viewpoint image.

The virtual viewpoint of the virtual viewpoint image displayed can be changed by the viewpoint operation unit.

In accordance with the change of the virtual viewpoint by the viewpoint operation unit, a virtual viewpoint image is generated as needed by the image generation unit 6 to be described below, and is displayed on the display unit. The display unit may be the display unit 7 to be described below or may be a separate display device. The viewpoint specification unit 5 generates virtual viewpoint information in response to the input through the viewpoint operation unit, and outputs the generated virtual viewpoint information to the image generation unit 6. The virtual viewpoint information includes information equivalent to camera external parameters such as the position and posture of the virtual viewpoint, information equivalent to camera internal parameters such as focal length and viewing angle, and time information for specifying the imaging time at which an image to be reproduced has been captured.

The image generation unit 6 acquires material data at the imaging time from the accumulation unit 4, based on the time information included in the input virtual viewpoint information. The image generation unit 6 uses the three-dimensional shape of the subject and the captured images in the acquired material data, and generates a virtual viewpoint image at the set virtual viewpoint and outputs the same to the display unit 7.

The display unit 7 is a display unit that displays the image input from the image generation unit 6. The display unit 7 is formed of a display, a head mounted display (HMD), or the like.

### (Tracking Method of Subject Position)

A tracking method of a subject position according to the present exemplary embodiment will be described.

The three-dimensional shape estimation unit 3 generates the three-dimensional shape of the subject and outputs the generated three-dimensional shape to the accumulation unit 4, and also outputs the generated three-dimensional shape to the shape extraction unit 11.

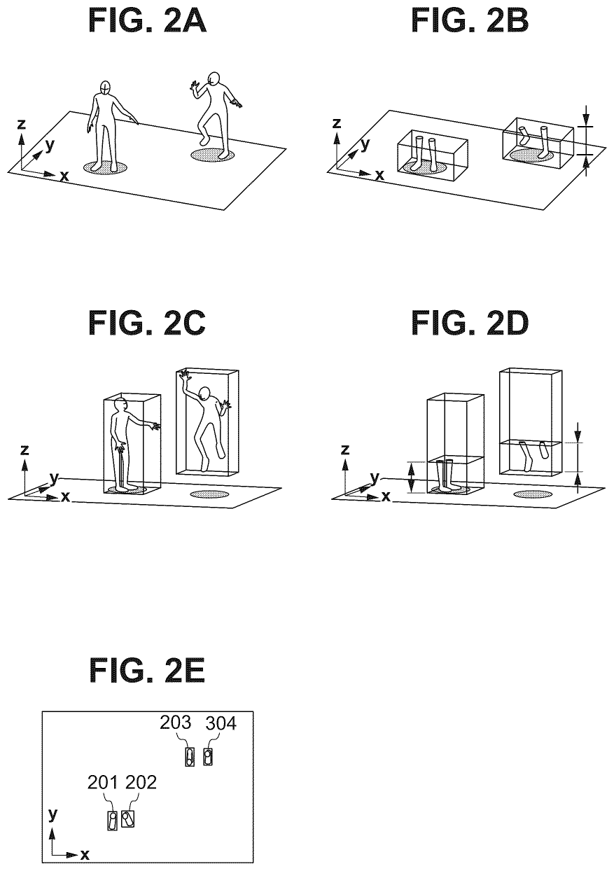

The shape extraction unit 11 cuts out the lower parts of three-dimensional shapes of subjects as illustrated in FIG. 2A, in a manner as illustrated in FIG. 2B. In the present exemplary embodiment, the three-dimensional shape of the subject is cut at a predetermined height (for example, a height equivalent to 50 cm) from the bottom surface of the circumscribed cuboid. For example, as illustrated in FIG. 2C, if a subject is standing and another subject is jumping and separated from the floor surface in the imaging area, the three-dimensional shapes of the subjects are cut as in the ranges illustrated in FIG. 2D. That is, both the three-dimensional shapes of the subjects are cut into parts equivalent to their feet at a predetermined height.

As illustrated in FIG. 2E, the shape extraction unit 11 projects the cut three-dimensional shapes onto a plane viewed from the top of the three-dimensional shapes of the subjects to generate two-dimensional images. In the present exemplary embodiment, the shape extraction unit 11 projects the cut three-dimensional shapes in parallel onto a two-dimensional plane equivalent to the feet (floor surface). In the present exemplary embodiment, the parallel-projected image is a binarized image in which the cut three-dimensional shape part is white and the other part is black. The shape extraction unit 11 divides the two-dimensional image into independent areas and determines their circumscribed rectangles 201 to 204 illustrated in FIG. 2E. The shape extraction unit 11 outputs vertex information on the circumscribed rectangles as extracted three-dimensional shapes (extracted shapes). In this case, the shape extraction unit 11 converts the vertex information on the circumscribed rectangles into the same coordinate system and unit as the three-dimensional space in the imaging area, and then outputs the same. The shape extraction unit 11 determines the independent shapes by using a method such as continuous component analysis on the projected two-dimensional image, for example. Using this method, the shape extraction unit 11 can divide the three-dimensional shape into individual areas.

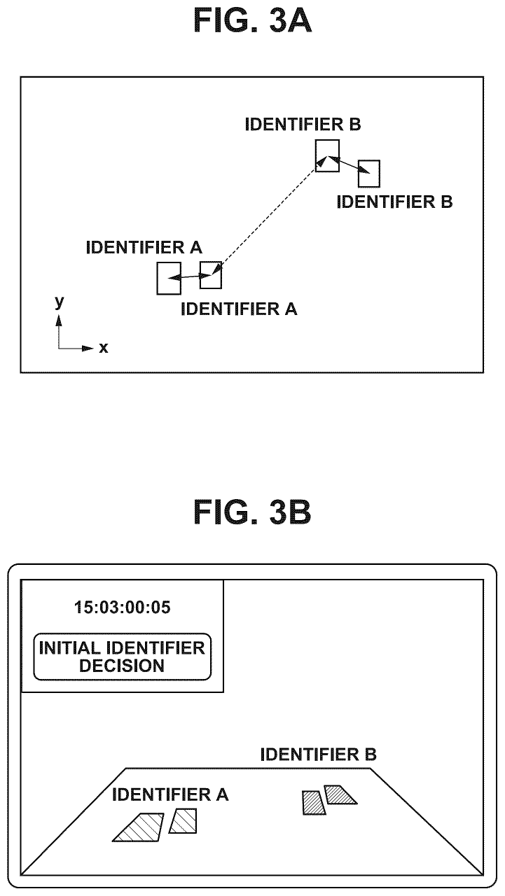

The identification setting unit 14 adds identifiers to the extracted shapes output from the shape extraction unit 11. Specifically, the identification setting unit 14 calculates the distances between the extracted shapes and adds the identifiers in accordance with the distances between the extracted shapes. For example, as illustrated in FIG. 3A, the identification setting unit 14 assigns the identical identifier to the extracted shapes between which the distance is shorter than a predetermined distance (solid arrows), and assigns different identifiers to the extracted shapes between which the distance is equal to or longer than the predetermined distance (broken-line arrows). The threshold for the predetermined distance used as a determination criterion is desirably equivalent to the dimension between the split legs of a standing subject. In the present exemplary embodiment, the threshold for the predetermined distance is set to 50 cm.

The identification setting unit 14 displays the assigned identifiers on the display unit of the identification setting unit 14 by a graphical user interface (GUI) as illustrated in FIG. 3B. The user operates the image processing system while watching the GUI. Specifically, the identification setting unit 14 displays the present identifier assignments (initial identifier assignments) on the graphical interface in a distinguishable manner using at least either characters or colors. Referring to FIG. 3B, the identification setting unit 14 displays the identifiers in both different characters and colors. The user checks the GUI to determine whether desired identifiers are assigned in the initial state. If the desired identifiers are not assigned, the user instructs the subject to change the standing position or close his/her legs, and repeatedly determines whether the desired assignments are achieved. Alternatively, the user operates the image processing system via the GUI to issue a change instruction to achieve the desired identifier assignments. If the desired identifiers are assigned, the user presses a decide button (initial identifier decide button) on the GUI as illustrated in FIG. 3B, for example. In response to this operation, the identification setting unit 14 determines the initial identifiers. The identification setting unit 14 outputs the identifiers assigned to the extracted shapes, to the tracking unit 12. When the identification setting unit 14 inputs the identifiers, the tracking unit 12 adds the identifiers to the extracted shapes as the initial state. Subsequently, the tracking unit 12 tracks the extracted shapes to which the identifiers are added. The identifiers added to the extracted shapes during the tracking are not the identifiers determined by the identification setting unit 14 but are identifiers determined on the basis of the results of tracking the positions of the extracted shapes by the tracking unit 12. At the tracking of the extracted shapes (tracking analysis), the tracking unit 12 tracks the extracted shapes based on the positions of the extracted shapes at the time previous to the imaging time of the extracted shapes, the identifiers of the extracted shapes, and the information on the subject position input from the subject position calculation unit 13 to be described below. The specific process of tracking by the tracking unit 12 will be described below. The tracking unit 12 adds the identifiers to the extracted shapes at that time based on the results of the tracking analysis, and outputs the extracted shapes to the subject position calculation unit 13.

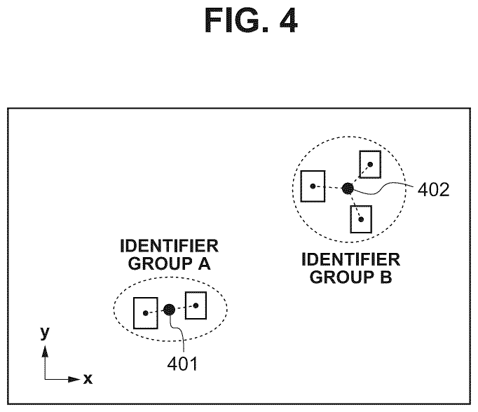

The subject position calculation unit 13 determines typical positions of the extracted shapes with the identifiers that are input from the tracking unit 12. For example, as illustrated in FIG. 4, the subject position calculation unit 13 determines the positions of extracted shape groups with the identical identifiers, such as typical positions 401 and 402. In the present exemplary embodiment, each typical position is located at the center of the extracted shape group.

Because the typical position may be under the influence of shape estimation errors and the fluctuation of the boundary part between the shapes cut by the shape extraction unit 11, the position of the subject may fluctuate from time to time even if he/she stands still. Accordingly, in the present exemplary embodiment, the subject position calculation unit 13 performs processing such as low-pass filtering and moving average on the central position information at each time in the temporal direction, and generates position information in which the high-frequency component is suppressed. The subject position calculation unit 13 outputs the position information on the typical positions together with the identifiers as the information on the position of the subject, to the tracking unit 12. The subject position calculation unit 13 records (accumulates) the information on the typical positions to which the information on the imaging time of the three-dimensional shapes as the original target of tracking analysis is added, as the information on the position of the subject (subject position information), in the accumulation unit 4.

### (Tracking Analysis Process by Tracking Unit 12)

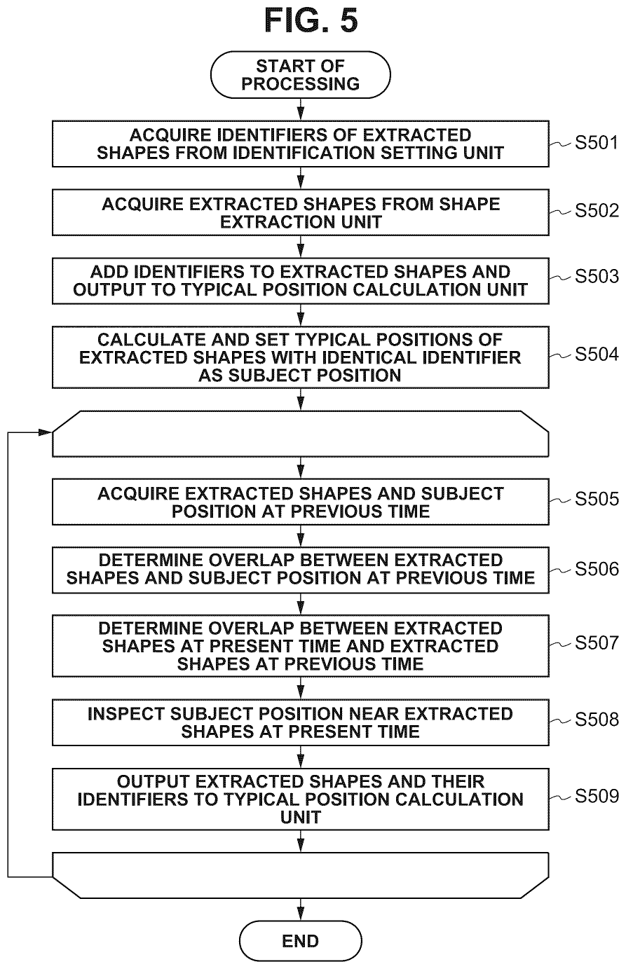

An example of tracking analysis process of extracted shape positions by the tracking unit 12 will be described with reference to the flowchart of FIG. 5.

In step S501, the tracking unit 12 performs an initialization process in response to an input from the identification setting unit 14. Specifically, the tracking unit 12 acquires the identifiers of the extracted shapes input from the identification setting unit 14.

In step S502, the tracking unit 12 acquires the extracted shapes input from the shape extraction unit 11.

In step S503, the tracking unit 12 adds the identifiers acquired from the identification setting unit 14 to the acquired extracted shapes, and outputs the extracted shapes with the identifiers to the subject position calculation unit 13.

In step S504, the subject position calculation unit 13 determines the subject position from the extracted shape group with the identical identifier, and outputs the same to the tracking unit 12.

Steps S501 to S504 are equivalent to the initialization process.

Steps S505 to S509 are performed at each time, and are repeatedly executed while the imaging units 1 are capturing images of the subject. When the process of imaging the subject by the imaging units 1 is completed, the processing in the flowchart is ended in response to completion of step S509.

In step S505, the tracking unit 12 acquires the extracted shapes input from the shape extraction unit 11 and the subject position at the previous time calculated by the subject position calculation unit 13. The previous time is the imaging time of the extracted shape generated earlier by one frame than the presently processed extracted shape, for example. The present time is the imaging time of the image used for generation of the presently processed extracted shape.

In step S506, if the previous-time subject position and the present-time typical positions of the extracted shapes overlap each other, the tracking unit 12 adds the identifiers of the subject position overlapping the typical positions, to the extracted shapes. In step S506, if the typical position of one extracted shape overlaps a plurality of subject positions, the tracking unit 12 adds the identifier indicating presently “undeterminable” to the extracted shape. In this step, the identifier indicating “undeterminable” is added because a plurality of extracted shapes with different identifiers may overlap at the present time such as in the state where two subjects are close to each other. The extracted shapes to which the identifiers including the identifier “undeterminable” are added are subject to step S509 described below.

In step S507, if the typical position of any extracted shape to which no identifier is yet added overlaps the previous-time extracted shape, the tracking unit 12 adds the identifier of the previous-time extracted shape to the present-time extracted shape.

In step S508, if there is another extracted shape to which an identifier is already added at the present time within a predetermined area from the extracted shape to which no identifier is yet added, the tracking unit 12 adds the identifier of the other extracted shape to the extracted shape with no identifier. The predetermined area is desirably an area equivalent to the distance between the split legs of the subject in a standing position. For example, the predetermined area is an area with a radius 50 cm from the center of the extracted shape. If there is a plurality of other extracted shapes with identifiers within the predetermined area from a certain extracted shape with no identifier, the tracking unit 12 adds the identifier of the closest extracted shape among the other extracted shapes to the extracted shape with no identifier. The tracking unit 12 determines the extracted shape with no identifier even after completion of step S508 as being excluded from the tracking target. In this case, the tracking unit 12 does not output the extracted shape determined as being excluded from the tracking target to the subject position calculation unit 13.

In step S509, the tracking unit 12 outputs the extracted shapes to which the identifiers have been added in steps S506 to S508 and the added identifiers, to the subject position calculation unit 13.

In step S510, a control unit not illustrated determines whether the process of imaging the subject by the imaging units 1 has been completed. If the control unit determines that the process of imaging the subject by the imaging units 1 has not been completed (NO in step S510), step S508 is executed. If the control unit determines that the process of imaging the subject has been completed (YES in step S510), the processing in the flowchart is ended.

In steps S506 to S508, the processing is performed on each extracted shape. When steps S506 to S509 are repeated, the identifiers set by the identification setting unit 14 are associated with the extracted shapes at each time. Using the identifiers, the subject position calculation unit 13 can determine the position of each subject in a distinguishable manner.

If the identifier “undeterminable” is added to the extracted shape by the tracking unit 12, some of the identifiers in the initial setting may not be added at a certain time. In this case, the subject position calculation unit 13 does not update the subject position information with the identical identifier to the identifier not added to any extracted shape. Accordingly, if some extracted shapes overlap due to a plurality of subjects coming closer to each other, the positions in a plurality of pieces of subject position information do not become the identical position. In this case, the plurality of subject positions is maintained as their respective positions until the previous time. After that, if the subjects separate from each other so that the plurality of overlapping extracted shapes separates again, identifiers are assigned to the extracted shapes based on the latest subject position. That is, the updating of each piece of subject position information is resumed in response to the canceling of the overlapping of the plurality of extracted shapes.

Even if there is a plurality of subjects within the imaging area, the image processing system can perform the process described above to track the individual subjects and acquire the position information on the individual subjects. Further, even if the generated three-dimensional shape models overlap each other or separate from each other when the subjects become close to each other or distant from each other, the image processing system can perform the foregoing process to track the individual subjects.

### (Display Process of Subject Information)

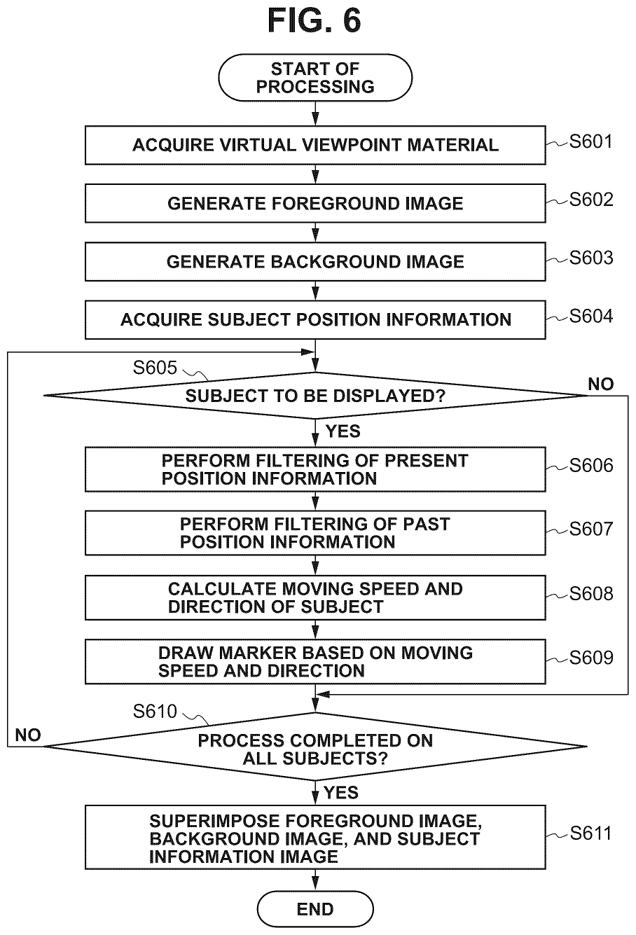

Methods of calculating and displaying the subject information according to the present exemplary embodiment will be described with reference to the flowchart illustrated in FIG. 6.

For the sake of description, the image generation unit 6 is assumed to include four units, a foreground image generation unit 61, a background image generation unit 62, a subject information image generation unit 63, and an image composition unit 64. However, the image generation unit 6 is not necessarily required to include the four units, and the image generation unit 6 may be formed as substantially one image generation unit.

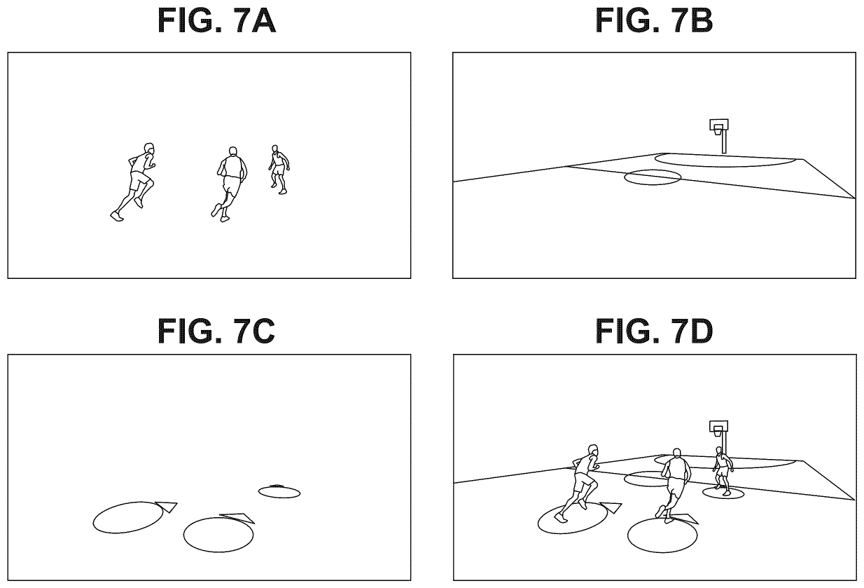

In step S601, the foreground image generation unit 61 acquires material data (virtual viewpoint material) accumulated in the accumulation unit 4, based on the time information included in the virtual viewpoint information. In step S602, the foreground image generation unit 61 generates an image of the foreground (subject) based on the acquired virtual viewpoint material. FIG. 7A illustrates an example of a generated foreground image. In step S603, the background image generation unit 62 generates a background image. The background is drawn using three-dimensional model data (mesh) and texture data saved in advance. FIG. 7B illustrates an example of a generated background image. Although the details will be described below, in steps S604 to S610, the subject information image generation unit 63 generates an image drawn with the information related to the subject at a position based on the subject position information. FIG. 7C illustrates an example of a subject information image generated at that time. In step S611, the image composition unit 64 combines the generated foreground image, background image, and subject information image into one image based on the depth information of these images, and outputs the same to the display unit 7. FIG. 7D illustrates an example of a composited virtual viewpoint image generated at that time. By performing steps S601 to S611 at each time, the subject information image generation unit 63 outputs the image with the subject information superimposed. That is, if the virtual viewpoint image is a moving image, the subject information image generation unit 63 performs steps S601 to S611 on each frame (image) constituting the moving image.

Specific operations of the subject information image generation unit 63 generating the subject information image will be described.

In step S604, the subject information image generation unit 63 acquires the position information on all the subjects included in the imaging area from the accumulation unit 4. At this time, the subject information image generation unit 63 acquires not only the subject position information at the time included in the virtual viewpoint information but also the subject position information of several to several tens of frames before and after that time. Subsequent steps S605 to S610 are performed on each subject. In step S605, the subject information image generation unit 63 determines whether to perform the subsequent steps, based on the identifiers of the subjects included in the position information and display target information described below. The display target information is data for use in specifying the target of subject information display, which is associated with the identifier of the subject. For example, the display target information is generated as data on players that are display targets based on player information, and is recorded in the accumulation unit 4. Accordingly, no subject information is displayed for referees and others that are not included in the display target information. Alternatively, the display target information may be generated by selecting the subjects to be displayed through an interface not illustrated. In step S606, the position information on the subject determined as a display target is subjected to a filtering process. Specifically, the position information is calculated by averaging the position information of the plurality of frames acquired in step S604. This reduces fluctuations in the subject position due to errors in detection by the subject position detection unit 8.

In step S607, the subject information image generation unit 63 acquires subject position information of several to several tens of frames at the time previous to the time of the display target subject, for example, the time one second earlier and before and after the previous time, and calculates the average value of the subject position information. In step S607, if the average value of the past subject position information determined in step S607 is equivalent to the averaged position information calculated in step S606 in the past, the subject information image generation unit 63 may read the equivalent position information. This reduces the processing load in step S607.

In step S608, the averaged position information at that time is subtracted from the past averaged position information, and the difference is divided by the difference between that time and the past time, one second in this case, thereby to determine the positional deviation per unit time at that time. The magnitude of the positional deviation per unit time indicates the moving speed of the subject, and the direction of the vector on a two-dimensional plane indicates the moving direction of the subject.

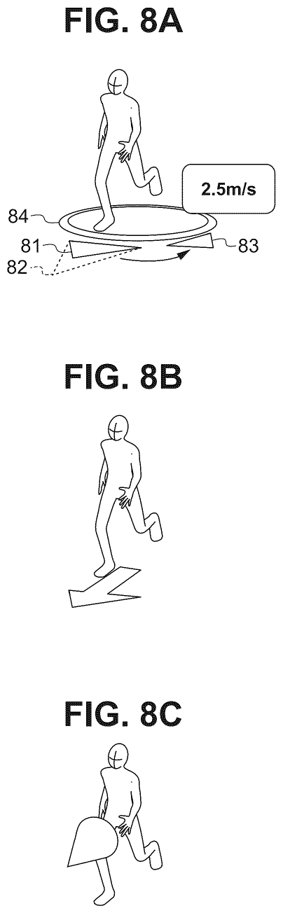

In step S609, the subject information image generation unit 63 draws a triangular moving direction mark as illustrated in FIG. 8A, for example, based on the calculated moving speed and direction of each subject, thereby generating a subject information image. In step S610, the subject information image generation unit 63 determines whether steps S605 to S609 have been completed on all the subjects. If steps S605 to S609 have not been completed on all the subjects (NO in step S610), step S605 and the subsequent steps are executed again. If steps S605 to S609 have been completed on all the subjects, the processing proceeds to step S611.

Finally, in step S611, the image composition unit 64 combines the generated foreground image, background image, and subject information image into one image based on the depth information of these images, and outputs the same to the display unit 7.

A moving direction mark 81 to be displayed with the subject information image is drawn in the moving direction of the subject as illustrated in FIGS. 8A to 8C. The moving direction mark is variable in size in accordance with the moving speed of the subject, and is drawn so as to be longer in the moving direction as the moving speed is higher like a moving direction mark 82, for example. If the moving direction mark is arranged at the center of the subject, the moving direction mark may be hidden behind the feet of the subject and the moving direction may be difficult to see. Thus, in the present exemplary embodiment, like a moving direction mark 83 illustrated in FIG. 8A, the moving direction mark is desirably drawn at a certain distance from the position of the subject and rotated in the drawing direction around the position of the subject in accordance with the moving direction. When the moving direction mark 81 is drawn at a certain distance from the subject position as illustrated in FIG. 8A, the moving direction mark 81 is drawn on the circumference of a circle around the subject position. Thus, drawing a circular mark 84 concentric to the drawing position of the moving direction mark desirably makes it easy for the user as a viewer to recognize the correspondence between the subject and the moving direction mark. As illustrated in FIG. 8A, the speed information may also be displayed by a numeric value.

Information based on past data such as the success rate of shooting corresponding to the position of the subject in the court or field may be displayed around the players.

With the system configuration described above, even if the viewpoint greatly changes in the virtual viewpoint image, it is possible to display the moving speed, the moving direction, and other additional information near the position of the subject displayed in the angle of view. This allows the user to check at what speed and in which direction each subject is moving even while performing an operation of changing the viewpoint in the state where the time of the virtual viewpoint image is stopped, thereby improving the viewer's experience. Besides, this technology can be used to provide coaching and commentary.

Some exemplary embodiments other than the first exemplary embodiment will be described. In the first exemplary embodiment, the subject position detection unit 8 is the unit to detect the subject position based on the results of shape estimation. However, the present disclosure is not limited to the method by which the position of the subject is detected. For example, position sensors such as global positioning system (GPS) sensors may be attached to players and the sensor values may be acquired. Alternatively, the subject position may be detected using an image recognition technique from images obtained by a plurality of imaging units.

In the first exemplary embodiment, the mark indicating the moving speed and the direction is a triangular icon (mark), but the shape of the mark in the present disclosure is not limited to this example. The mark may have an arrow shape as illustrated in FIG. 8B or may have any other shape. For example, although the mark is displayed around the floor in the first exemplary embodiment, a cone-shaped mark may be displayed at the waist height of a player as illustrated in FIG. 8C, for example. In FIG. 8A, only the dimension (length) of the moving direction is changed, but the size of the mark itself may be changed, or the color of the mark may be changed. For example, the mark may be displayed in a blue color when the subject is moving at a low speed, and may be displayed in a red color when the subject is moving at a high speed. The mark may be given a plurality of pieces of information in such a manner that its shape is changed in accordance with the moving speed and its color is changed in accordance with the acceleration.

In the first exemplary embodiment, if there is a subject that is not to be displayed among a plurality of subjects, the position information and the moving speed of that subject are not calculated. Alternatively, the position information and the moving speed of that subject may be calculated even though they are not to be displayed.

In the present exemplary embodiment, the subject information image generation unit 63 calculates the moving speed and the direction in each frame at the time of generation of a virtual viewpoint image. However, the present disclosure is not limited to this configuration. For example, the subject position detection unit 8 may detect the subject position, calculate the moving speed and the direction, and record the same in the accumulation unit 4. In this case, the subject information image generation unit 63 may acquire the position information and the information on the moving speed and the direction, and draw a mark using the same.

In the first exemplary embodiment, the averaging process is performed as the filtering process of the position information. However, the processing in the present disclosure is not limited to this example. For example, a low-pass filter such as an infinite impulse response (IIR) filter or a finite impulse response (FIR) filter may be used. However, in the case of calculating the moving speed each time, the use of a low-pass filter may result in incorrect values if the reproduction time of the virtual viewpoint image is changed in a discontinuous manner. In such a case, it is desirable to acquire and average the information at times around the reproduction time.

If the moving speed information is calculated in advance and accumulated in the accumulation unit 4 as described above, the moving speed information on a specific player may be displayed in graphical form. For example, the acceleration may be determined from the history of the moving speed, and if the acceleration of the player is decreasing, the degree of his/her fatigue may be determined and displayed in a simple manner.

Other configurations will be described. In the above-described exemplary embodiment, the processing units illustrated in FIG. 1 are formed of hardware. However, the processes performed by these processing units illustrated in the drawing may be formed of computer programs.

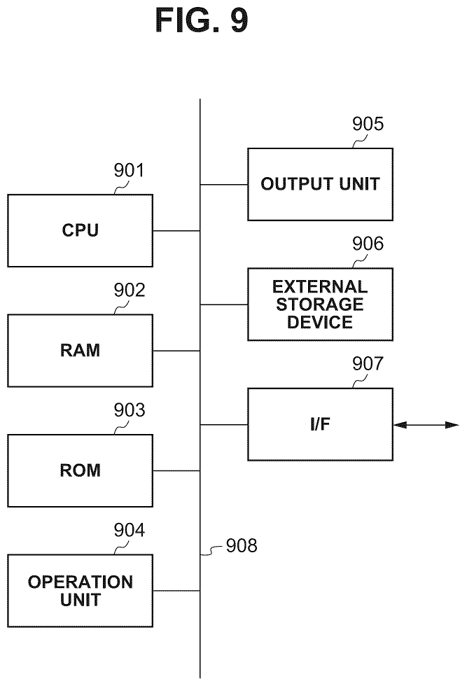

FIG. 9 is a block diagram illustrating a configuration example of hardware of a computer that is applicable to an indirect position estimation apparatus according to the above-described exemplary embodiment.

A central processing unit (CPU) 901 controls the overall computer using computer programs and data stored in a random access memory (RAM) 902 and a read only memory (ROM) 903, and executes the processes described above as being performed by the indirect position estimation apparatus according to the above-described exemplary embodiment. That is, the CPU 901 functions as the processing units illustrated in FIG. 1.

The RAM 902 has an area for temporarily storing computer programs and data loaded from an external storage device 906, data externally acquired via an interface (I/F) 907, and others. The RAM 902 further has a work area for the CPU 901 to execute various processes. That is, the RAM 902 can assign frame memories or provide other various areas as appropriate, for example.

The ROM 903 stores setting data and boot programs of the computer. An operation unit 904 is formed of a keyboard and a mouse, and is operated by the user of the computer to input various instructions to the CPU 901. An output unit 905 displays the results of processing by the CPU 901. The output unit 905 is formed of a liquid crystal display, for example. The viewpoint specification unit 5 is equivalent to the operation unit 904, and the display unit 7 is equivalent to the output unit 905, for example.

An external storage device 906 is a large-capacity information storage device that is typified as a hard disk drive device. The external storage device 906 saves an operating system (OS) and computer programs for the CPU 901 to implement the functions of the units illustrated in FIG. 1. Further, the external storage device 906 may save image data to be processed.

The computer programs and data saved in the external storage device 906 are loaded into the RAM 902 as appropriate under the control of the CPU 901, and are processed by the CPU 901. The I/F 907 can be connected to networks such as a local area network (LAN) and the Internet, and to other devices such as a projection device and a display device. The computer can acquire and send various kinds of information via the I/F 907. In the first exemplary embodiment, the imaging units 1 are connected to the I/F 907 to input and control captured images. A bus 908 connects the above-described units.

The operations of the above-described components are mainly controlled by the CPU 901 as described above in relation to the exemplary embodiments.

Another configuration is achieved by recording codes of computer programs to implement the above-described functions on a storage medium, supplying the storage medium to a system, and reading and executing the codes of computer programs by the system. In this case, the codes of computer programs read from the storage medium implement the functions of the above-described exemplary embodiments, and the storage medium storing the codes of computer programs is a configuration of the present disclosure. In response to instructions from the codes of programs, the OS running on the computer may perform some or all of the actual processes, so that the above-described functions can be implemented by the processes.

The following exemplary embodiment may be implemented. That is, the codes of computer programs read from a storage medium may be written into a function enhancement card inserted into a computer or a memory provided in a function enhancement unit connected to the computer. In response to instructions from the codes of computer programs, the CPU or the like included in the function enhancement card or the function enhancement unit may perform some or all of the actual processes to implement the above-described functions.

In the case of applying the present disclosure to the above-described storage medium, the storage medium stores the codes of computer programs corresponding to the processes described above.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-097066, filed Jun. 13, 2023, which is hereby incorporated by reference herein in its entirety.

What is claimed is:

1. An image processing apparatus comprising:
one or more memories storing instructions; and
one or more processors executing the instructions to:
detect a position of a subject;
generate a virtual viewpoint image using three-dimensional shape data of the subject; and
display subject information related to movement of the subject on the virtual viewpoint image, based on information on the detected position of the subject.

2. The image processing apparatus according to claim 1,
wherein the one or more processors further execute the instructions to acquire a moving speed and a moving direction of the subject based on the position information of the subject at a plurality of times; and
wherein the one or more processors execute the instructions to display the moving speed and the moving direction as the subject information.

3. The image processing apparatus according to claim 2, wherein the one or more processors execute the instructions to indicate the moving direction of the subject using an arrow-shaped or triangular icon near the subject position, as the subject information.

4. The image processing apparatus according to claim 3, wherein the one or more processors execute the instructions to change at least one of size, length, and color of the icon indicating the moving direction, based on the acquired moving speed of the subject, as the subject information.

5. The image processing apparatus according to claim 3, wherein the one or more processors execute the instructions to display an icon with a circular shape or a shape surrounding the subject near feet of the subject, based on the position information of the subject, as the subject information.

6. The image processing apparatus according to claim 1, wherein the one or more processors execute the instructions to, in a case where a plurality of subjects is seen in the virtual viewpoint image, information based on the position information of each subject is displayed.

7. The image processing apparatus according to claim 6, wherein the one or more processors execute the instructions not to display the subject information on a subject that is included in the three-dimensional shape data of the subject but is not specified in advance.

8. An image processing method comprising:
detecting a position of a subject;
generating a virtual viewpoint image using three-dimensional shape data of the subject; and
displaying subject information related to movement of the subject on the virtual viewpoint image, based on information on the detected position of the subject.

9. A non-transitory recording medium recording a program for causing an image processing apparatus to execute a control method, the control method comprising:
detecting a position of a subject;
generating a virtual viewpoint image using three-dimensional shape data of the subject; and
displaying subject information related to movement of the subject on the virtual viewpoint image, based on information on the detected position of the subject.
